(19) United States
(12) Patent Application Publication
(10) Pub. No.: US 2020/0238486 A1
(43) Pub. Date: Jul. 30, 2020

(54) TORQUE CONTROL DEVICE FOR PULSE TOOLS AND METHOD OF MONITORING TORQUE FOR PULSE TOOLS

(71) Applicant: DANIEL DALLAS TSAI, TAICHUNG CITY (TW)

(72) Inventor: SHIH-YU HUANG, TAICHUNG CITY (TW)

(21) Appl. No.: 16/256,074

(22) Filed: Jan. 24, 2019

(51) Int. Cl. B25B 23/145; B25B 21/02

(52) U.S. Cl. CPC B25B 23/1453; B25B 23/1456; B25B 21/02

(57) ABSTRACT

A non-intrusive torque control device for pulse tools, and a method of monitoring torque of pulse tools include steps of establishing a characteristic curve (FIG. 6) specify relation of revolution-per-minute (or BPM) with output torques for a specific pulse tool. Then establish another relationship curve (FIG. 7) specify operational factors (such as supply air pressure) with revolutions-per-minute (or BPM) for the same pulse tool at calibration stage. Those two curves and threshold are stored in flash memory of BPM detector (part of torque control system). The BPM detector is attached on the surface of pulse tool at nearby of impact mechanism. When fastening a bolt, at tightening stage while the impact reach the threshold stored in memory of BPM detector then start monitoring. This is a complete close loop torque control exclusive for pulse tool only. Target torque can be pre-set manually or automatically if a wireless control proportional valve is available connected to air source. In other word, impact mechanism inside pulse tool is same as install single or double hammer Increase BPM (rpm) of impact mechanism has the same effect as increase hammer knocked speed and has been proven by characteristic curve (FIG. 6).

### BACKGROUND OF THE INVENTION

### 1. Fields of the Invention

The present invention relates to a non-intrusive torque control device for pulse tools, and a method of monitoring torque of pulse tools.

### 2. Descriptions of Related Art

Most conventional pulse tools are not cataloged in acceptable torque control tools, because output torque of pulse tools are in a form of pulse waves instead of continuity. Even though pulse tools are able to output high pulse torque. Still, output torque is difficult to be controlled. There are so many factors that affect the output value of the pulse tools, such as pressure, air flow, and size of motor, even mass of socket driven by pulse tool—etc. The conventional method for controlling the output torque of pulse tools by using one or two factors mentioned above on pulse tools might be referenced as open loop control only.

The common way to control output torque of conventional pneumatic tools usually is to control pressure or flow of supply air source. This method requires stable pressurized air supply and constant flow. Different air flow with the same pressurized air sources may have different output torque.

Above approach is still an open loop control not close loop control and is unable to feedback actual output torque precisely. In other word, it can't be classified as a real time machine.

Some torque control systems for pulse tool developed by famous tool makers worldwide such as Stanley PSI, Atlas Pulsor C torque control devices use torque sensor mounted at output shaft of pulse tool to detect output torque, and use shut off valves to stop supply air once the pre-set torque is detected by torque sensor. The precision of torque control may vary up to +/−50% due to following uncontrollable variants.

1. System is relied on torque sensor to detect torque, once pre-set torque is reach, supply air will be shut off, and only one or two pulse torque which are equal to target torque were presented on output of pulse.

2. Response time of electro-magnetic valve is about 30 micro seconds. Would be enough to respond for shut off supply air in time?

3. Since torque sensor is attached at output shaft, it senses output pulse torque not real torque fastened by pulse tool. This is a very important concept to distinguish whether a system is open or close loop control.

4. Add more socket, linkage between bolt and output shaft of pulse tool will increase inertial and decrease dynamic impact from output of pulse tool. In other word, the pulse torque actually apply to work piece (bolt or nut) is smaller than the output torque of tool if socket is attached.

One prior patent uses an encoder attached at rear end of the motor to calculate the number of revolution. Unfortunately, this method cannot distinguish the number of revolutions is when the tool at tightening process or at free spin. In free spin, tangent speed,

$$V = \frac{2 P i \times R \times rpm}{60} ,$$

but without velocity differential ΔV , therefore, Momentum=ΔV×m (the mass of the impact mechanism)=0, and no output torque during free spin

$$T = F \times R = m A \times R = m \frac{Δ V}{Δ t} \times R = 0 .$$

To Judge pulse tool is at free spin or at tightening process, strain gauge might be installed, as well as related control circuit and make system more complicated and increase cost as well. Besides, by nature vibration generated by pulse tool will definitely affect the performance of encoder attached nearby impact mechanism.

One of a latest method known to applicant uses highest pressurized air source and lowest work pressurized air source respectively to drive the pneumatic tool, and to obtain the highest and lowest output torques of tool. The highest and lowest output torques establishes a curve regarding the pressure and the torque. Within range of this curve, users can input a target value of the output torque to obtain the related pressure required. There are some variable factors will have effect of this method, such as how to define the highest and lowest pressures of the pulse tools. What if the curve is obtained by not using the acceptable highest and lowest pressures? Can the users to find out the needed pressure and torque by using the curve mentioned above?

The prior patent uses the lowest pressure PL to match with the lowest torque TL, and the highest pressure PH to match with the lowest torque TH, so as to obtain a curve relate to pressure and torque, without considering the size of the hoses, flow of air, and even the wearing of the motor, so that the output Power=Pressure×Flow will vary accordingly.

The main problem of the prior patent is that it is still an open loop control, wherein many of the factors are not consistent, so that the actual output torque often differs from pre-set torque due to change of actual conditions or parameters.

Since torque generated by pulse tool is a series of pulse torque or impact and is not easy be measured by torque meter. The prior patent uses a torque sensor that is mounted to the output end of the pulse tool try to detect the output torque is not suggested. Besides, socket, links add together in front of pulse tool to compose total mass will increase dynamic inertia and reduce actual torque transmitted from tool to work piece.

The present invention intends to provide a non-intrusive close loop torque control device for pulse tools and a method of monitoring torque of pulse tools to eliminate the shortcomings mentioned above.

### SUMMARY OF THE INVENTION

The purpose of the present invention is to provide a torque control device for pulse tools, and a method of monitoring torque of pulse tools, and comprise steps of establishing a characteristic curve specify relation of revolution-per-minute (or BPM) and output torques for a specific pulse tool, and a relationship curve specify relation of operational factors and revolutions-per-minute (BPM) of pulse tool. When a bolt driven by pulse tool at tightening process, BPM detector start to monitor the beat-per-minute (BPM) of pulse tool and calculate output torque of pulse tool according to characteristic curve established at calibration stage in order to match the goal of pre-set torque.

To achieve this, the present invention provides a method for monitoring output torque of pulse tools, and comprises the following steps:

A step of establishing a characteristic curve with relationship of beat per minute (BPM) and the output torques of the pulse tool. The characteristic curve is stored in a memory unit of BPM detector.

A step of establishing a relationship curve of operational conditions and beat per minute (BPM) of pulse tool at tightening process. The relationship curve is stored in the memory of torque controller.

A step of connecting a pulse tool to a power source, a torque controller contains a beat-per-minute detector (BPM detector). The pulse tool driving an object such as a bolt, at tightening process, if pulse torque is bigger than the threshold set inside BPM detector, then start to count the bpm of pulse tool during tightening process. Based on bpm and mass of impact mechanism inside pulse tool, Output torque of pulse tool can be calculated, no matter how long the tightening process is applied.

The present invention also relates to a non-intrusive torque control device for pulse tools, and comprises a proportional valve that is connected between a pulse tool and a pressurized air source. The proportional valve receives operational conditions of torque-setting from a torque controller, and adjusts operational conditions of torque-setting. A beat-per-minute detector (BPM detector) is attached at outside of the pulse tool and has an accelerometer as a core component to detect impact pulse of the pulse tool at tightening process and compute the BPM. The torque controller has a micro processer, related hardware, software. A characteristic curve is a relationship between BPM or revolution-per-minute and output torques of the pulse tool. Another curve is a relationship curve for operational factor (such as air pressure or flow) and rotation speed for specific pulse tool.

The present invention can be either a simple torque gauge of pulse tool for real time torque feedback at tightening process, or service as part of a close loop torque control system for pulse tool as well if calibration process has been performed before and two curves including characteristic curve of specific pulse tool already built up and stored inside the flash memory of Torque Control Unit.

For torque control: Step1, user set the target torque. Step2, to find related BPM from characteristic curve of specific pulse tool. Step3, to find relate air pressure from relationship curve of specific pulse tool. Note: Air pressure can be set manually or automatically if a wireless RF control proportional valve is available.

The present invention will become more obvious from the following description when taken in connection with the accompanying drawings listed below, for purposes of illustration only, a preferred embodiment in accordance with the present invention.

### BRIEF DESCRIPTION OF THE DRAWINGS

FIG. 1 shows that a BPM detector is attached to surface of pulse tool at a nearby impact mechanism;

FIG. 2 shows that the BPM detector is removed from the pulse tool;

FIG. 3 is an exploded view to show the BPM detector of the present invention;

FIG. 4 shows that the pulse tool is connected to the BPM detector and the proportional valve to check the output torque;

FIG. 5 shows the operation of the present invention;

FIG. 6 shows the characteristic curve specify relationship of revolution-per-minute (or BPM) and output torque of specific pulse tool for present invention.

FIG. 7 shows the relationship curve specify operational factors (such as supply air pressure) and revolutions-per-minute (or BPM) for the same pulse tool of present invention.

FIG. 8 shows the Evaluation data of present invention.

### DETAILED DESCRIPTION OF THE PREFERRED EMBODIMENT

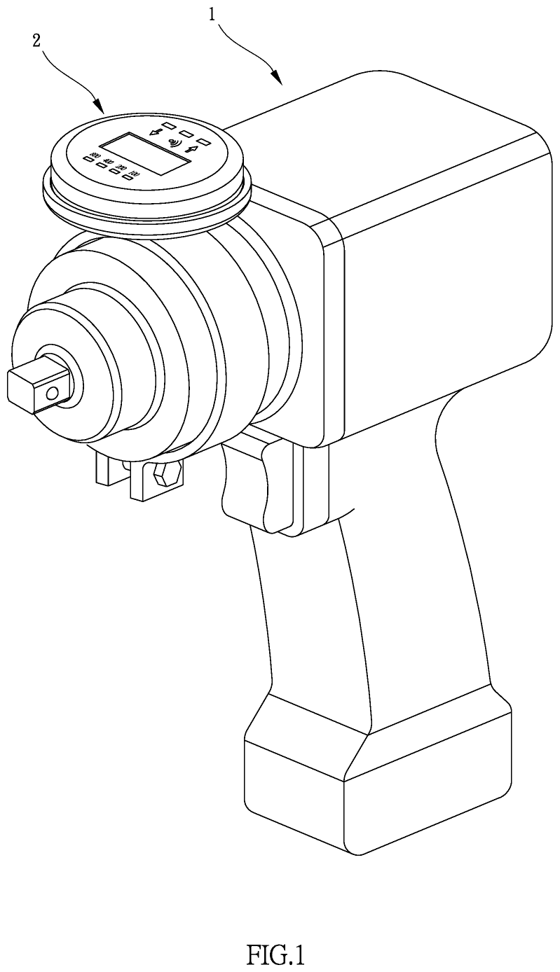

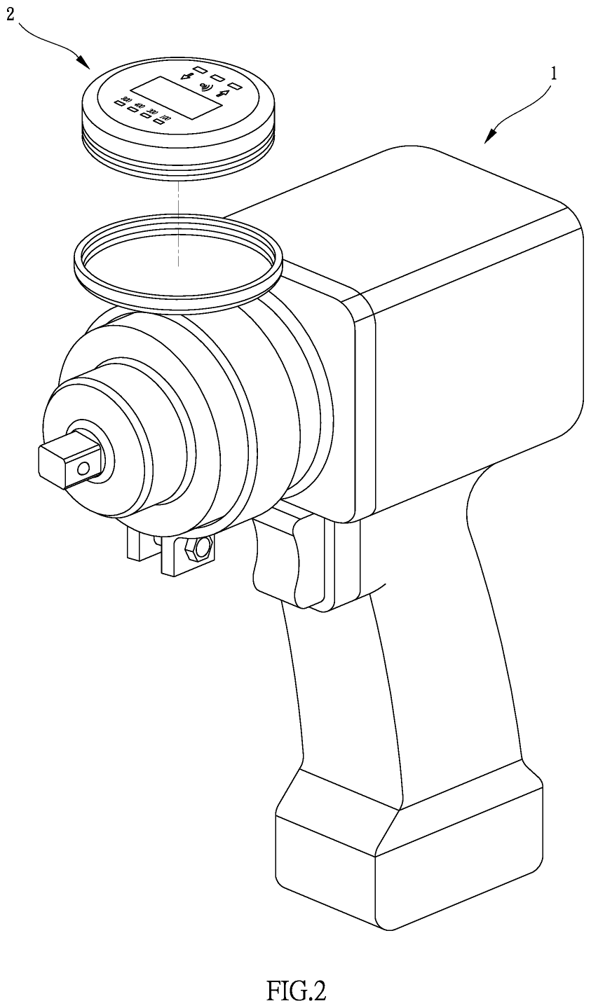

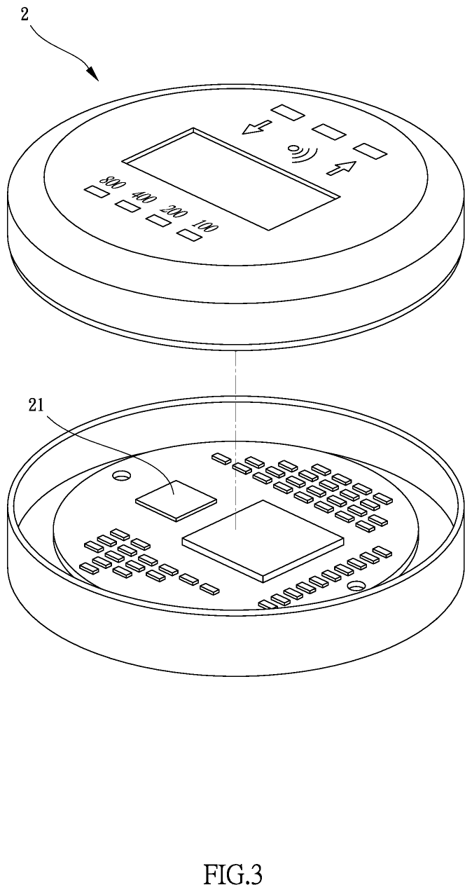

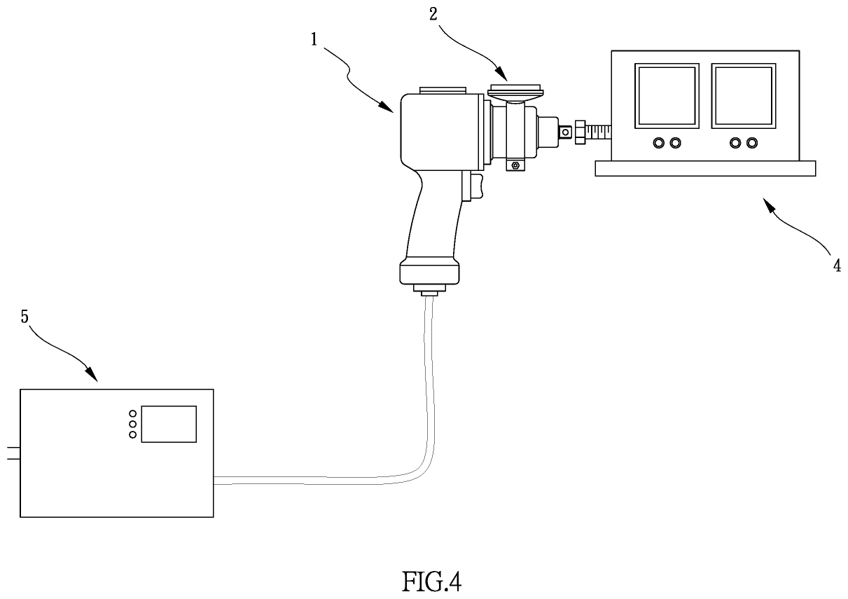

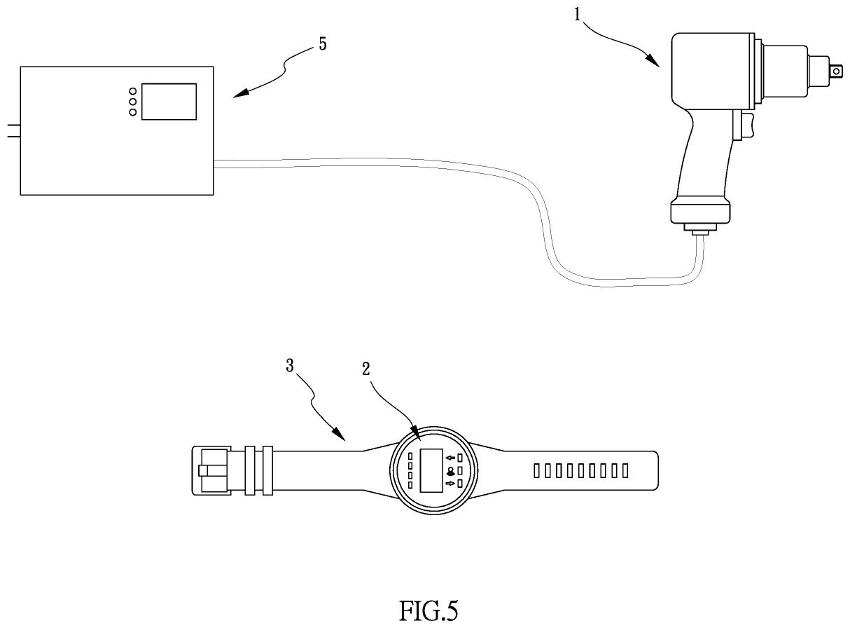

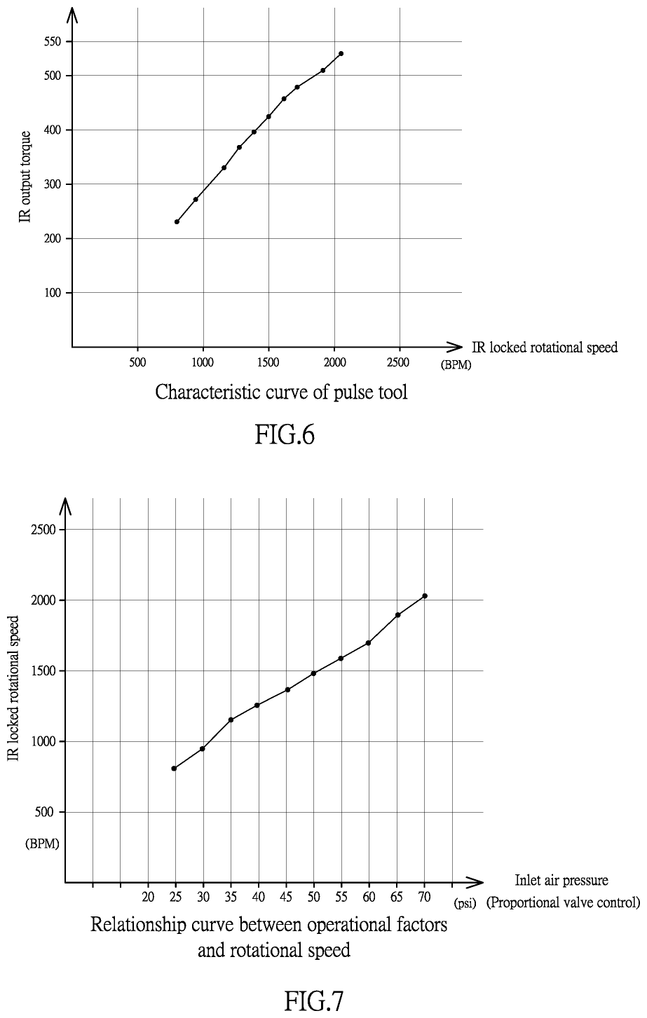

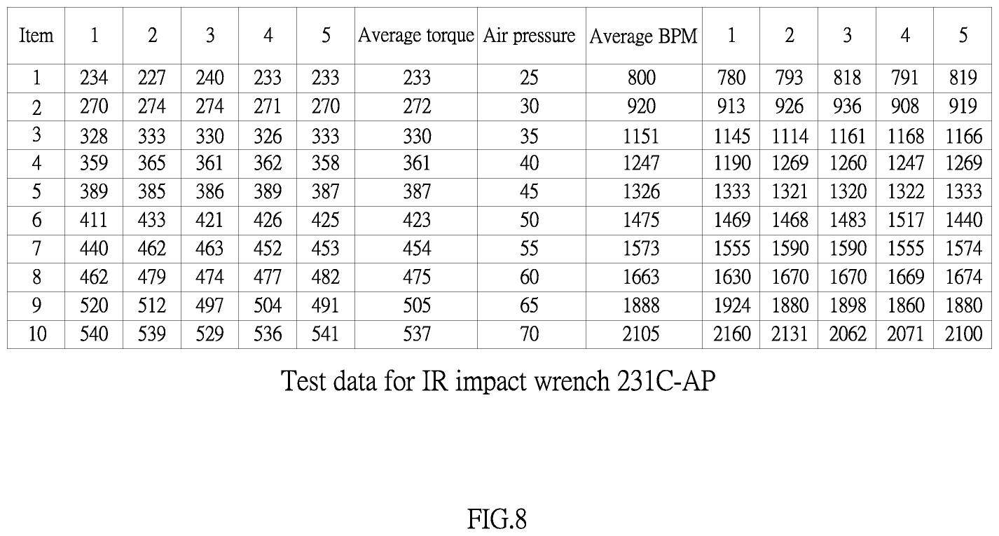

Referring to FIGS. 1 to 8, the non-intrusive method of monitoring torque of pulse tools comprises the following steps:

A step of connecting a pulse tool 1 to a stable power source such as a pressurized air source or an electric power source, a proportional valve 5, a torque controller 3, and a beat-per-minute detector 2 (BPM detector) which can also be integral with the torque controller 3. At tightening process, the pulse tool 1 is connected with a torque measurement platform 4 to detect an output torque from the pulse tool 1 so as to obtain torque and threshold stored in a storage unit in the BPM detector 2. When a value detected is below the threshold, this means that the pulse tool 1 is at free spin status (not at tightening process).

A step of establishing a characteristic curve specified relationship of revolution-per-minute (or BPM) and output torque of specific pulse tool 1. The characteristic curve is obtained when the pulse tool 1 is at tightening process. The characteristic curve is stored in a memory unit of the torque controller 3.

A step of establishing a relationship curve specified operational factors (such as supply air pressure) and revolutions-per-minute (or BPM) for the same pulse tool 1. The relationship curve is stored in the memory unit of the torque controller 3.

When fastening a bolt, the target torque is set by user into torque controller 3, and user refers related BPM and operation factors (such as air pressure) displayed on controller calculated from the characteristic curve and the relationship curve. Real operation factors such as air pressure can be set by user manually or set by wireless proportional valve 5 automatically if available. At tightening process the BPM detector 2 keeps monitoring whether or not the output torque from the pulse tool 1 falls in the tolerance range of the target torque so as to achieve the purpose of monitoring the output torque.

The output torque from the pulse tool 1 is:

$$T = r \times F = r \times m \times a = r \times m \times \frac{d V}{d t} \qquad ( formula 1 )$$

The maximum tangent speed of impact unit is:

$$Vt = 2 P i \times \frac{r}{d t} = r \times \frac{2 P i}{d t} = r \times ω \qquad ( formula 2 )$$

The initial tangent speed of impact unit at tightening process at each cycle start is:

Vi=0 (formula 3)

The speed difference of the impact unit (the radius of the impact unit×angular speed):

$$dV = Vt - Vi = 2 P i \times \frac{r}{d t} = r \times ( \frac{2 P i}{d t} ) = r \times ω \qquad ( formula 4 )$$

The speed difference dv is applied into the formula 1:

$$T = r \times m \times \frac{d V}{d t} = r \times m \times r \times \frac{ω}{d t} = m \times ω ( \frac{{r}^{2}}{d t} ) = I \times ω \times C = J \times ω \qquad ( formula 5 )$$

The output torque of the pulse tool 1 at tightening process is decided by the maximum angular speed ω. The average angular speed of each impact is reasonably deemed as ½ ω. The rotational speed of the impact unit is

$$rpm = ( \frac{2 P I}{60} ) \frac{radian}{s} = ( \frac{2 P I}{60} ) \times ( \frac{1}{2} ω ) = ( \frac{P i}{60} ) \times ω$$

It is difficult to detect the maximum angular speed ω and the impact time dt. However, there are many ways to detect the rotational speed of the impact unit rpm, including adding an encoder at rear end of the motor, but it is not feasible as mention above.

It is suggested to attach a BPM detector on surface of pulse tool 1 at nearby of impact mechanism, and the threshold is set so as to detect BPM as rpm (single hammer mechanism) or ½ rpm (double hammer mechanism).

The dt means the period of time at tightening process, when the tangent speed drops from the maximum tangent speed to 0 of the impact unit at end of each impact cycle. The dt may vary along with different material of the impact unit, and the difference of the dt is deemed as a constant C because material of impact mechanism is steel most likely. The rotational momentum is I=m×(r²) which is applied into the formula 5 so that the output torque of the pulse tool 1T=I×ω×C=J×ω.

The output torque T is proportion to the rotational speed of the impact unit, and can be related from the characteristic curve. The rotational speed or angular speed of the pulse tool 1 at tightening process is directly proportional to the output torque T of the impact unit within a certain range.

Under different operational conditions such as pressure, air flow, conditions of the motor, rpm of the pulse tool 1 at tightening process is affected as shown at relationship curve. By checking relationship curve, rpm of the impact unit at tightening process can be monitored so as to control the output torque through referring characteristic curve to achieve purpose of torque control.

The present invention may refer one of specific operational factors (pressure, flow, or impact mechanism) as operational factor to build the relation curve with rpm of pulse tool 1. At tightening process, angular speed raises from 0 at cycle start to the maximum angular speed ω.

$$The maximum tangent speed Vt = 2 Pi \times r \times ω . \\ Speed difference Δ V = Vt - V i = 2 P i \times r \times ω$$

$$Impact momentum momentum = m \times Δ V$$

$$Impact force F = m \times \frac{Δ V}{Δ t} . \\ Pulse torque T = r \times F = {r}^{2} \times 2 P i \times ω = I \times ω \times C = J \times ω .$$

Output torque T of the pulse tool 1, at tightening process is directly proportional to BPM (angular speed ω) as seen in the characteristic curve 6 of specific pulse tool.

Power=Air pressure×Air flow drives air motor to rotate impact unit 1, the maximum angular speed can be controlled by the control of the operational factors as stated in relation curve 7.

If pulse tool 1 isn't at tightening process, for instance free spin, the output shaft of the pulse tool is co-rotated with the impact unit. Tangent speed Vt=2Pi×r×ω does not drop to 0. In other words, both angular rate ω and tangent speed V keep constant, except speed difference ΔV=0. Even though the total dynamic energy is built up at output shaft of pulse tool 1, still zero output torque is presented at pulse tool 1 due to zero momentum (ΔV=0). This is a key reason to explain why BPM detector is suitable for torque control of pulse tool other than encoder attached at end of motor. Encoder is capable of detecting angular speed but has no way to judge whether or not pulse tool is at tightening process.

As shown in FIGS. 1 to 5, the BPM detector 2 is connected to the surface of pulse tool 1. Place pulse tool 1 on measurement platform 4 to start calibration. At tightening process, threshold obtained from the torque measurement platform 4 is stored in the storage unit of the BPM detector 2. Relationship between BPM and output torque to establish characteristic curve, and relationship between BPM and operation factors (such as supply air pressure) to establish relationship curve are stored in memory as well.

As shown in FIGS. 1 to 5, the torque control device for pulse tools of the present invention is connected between the power source and the pulse tool 1, and comprises a BPM detector 2 which uses the accelerometer 21 to detect the beats per minute of the impact unit, and the beats per minute of the impact unit is used to calculate the revolutions per minute. A torque controller 3 has a micro processer so as to establish a characteristic curve between revolution-per-minute of an impact unit in the pulse tool 1 and output torques of the pulse tool 1, and a relationship curve between operational factors of the pulse tool 1 and the revolutions-per-minute of the impact unit in the pulse tool 1. The two curves are stored in the microprocessor of the torque controller 3. When set target torque in pulse tool 1, the target value is input to the torque controller 3, and the torque controller 3 calculates the revolutions per minute of the impact unit corresponding to the target value. The operational factors are displayed on the liquid display panel of the torque controller 3. If there is a proportional valve 5, the proportional valve 5 automatically adjusts the operational factors corresponding to the target torque. Otherwise, the operational factors can be adjusted manually according to the display information on the display panel. When pulse tool 1 start to fasten a bolt, BPM Detector checks the characteristic curve and the relationship curve at tightening process. The microprocessor in torque controller 3 compares the BPM values and checks whether or not the BPM values fall into the tolerance range. If the BPM values fall into the tolerance range, a green LED lights up, if the BPM values fall out of the tolerance range, a warning red LED lights up.

What is claimed is:

1. A method of monitoring torque for pulse tools, comprising:
connecting a pulse tool to a power source, a torque controller, and a beat-per-minute detector (BPM detector), wherein a torque measurement platform is used for pulse tool at tightening process to perform calibration procedure, where the threshold of output torque is stored in a flash memory of the BPM detector;
calibrating the relationship of revolution-per-minute (or BPM) with output torques of the pulse tool, then establishing a characteristic curve and stored in memory of the BPM detector and the torque controller;
calibrating the relationship of operation factors with revolution-per-minute (or BPM) of pulse tool, then establishing a relation curve and stored in memory of the BPM detector and the torque controller.

2. The method as claimed in claim 1, further comprising:
connecting the BPM detector to the pulse tool while pulse tool is operated, the torque measurement platform defining the threshold and stored in the storage unit of the BPM detector; and
through the torque measurement platform establishing a characteristic curve specify relationship of revolutions-per-minute (or BPM) with the output torques and a relationship curve specify relationship of operation factor with revolutions-per-minute (or BPM) for a specific pulse tool at tightening process, then stored in the memory unit of the torque controller.

3. The method as claimed in claim 1, further comprising using a microprocessor in the torque controller to compare BPM values with a preset value of the BPM detector at tightening process within tolerance range, a warning signal generated when the values detected by the BPM detector fall outside a tolerance range.

4. The method as claimed in claim 1, wherein a pulse tool which has been calibrated before runs through a confirmation on the torque measurement platform, the confirmation including comparing BPM values detected from the BPM detector and output torque of the pulse tool to be matched with the characteristic and relation curves of a specific pulse tool.

5. The method as claimed in claim 2, wherein a pulse tool which has been calibrated before runs through a confirmation on the torque measurement platform, the confirmation including comparing BPM values detected from the BPM detector and output torque of the pulse tool to be matched with the characteristic and relation curves of a specific pulse tool.

6. The method as claimed in claim 3, wherein a pulse tool which has been calibrated before runs through a confirmation on the torque measurement platform, the confirmation including comparing BPM values detected from the BPM detector and output torque of the pulse tool to be matched with the characteristic and relation curves of a specific pulse tool.

7. A torque control device for pulse tools, comprising:
a proportional valve connected between a pulse tool and a pressurized air source, the proportional valve receiving operational conditions of torque-setting from a torque controller, and adjustable operational factors by setting operational parameters;
a beat-per-minute detector (BPM detector) attached on surface of pulse tool with accelerometer as core component to detect pulses generated by pulse tool at tightening process to calculate BPM, then compute BPM into revolutions per minute depends on single or double hammer mechanism inside pulse tool;
a torque controller with a micro processer, a characteristic curve of BPM related with output torque and an operation curve of BPM or RPM relate with operation parameters such as pressure of supply air source of specific pulse tool was set up at calibration stage; and
a storage unit located in the BPM detector and storing threshold of pulse tool, characteristic curve and relationship curve
wherein, before a fastening process, the torque controller converts target torque set by user into revolutions-per-minute or BPM, and operation parameter corresponding to target torque referred from characteristic curve and operation curve stored in flash memory at calibration stage, and
wherein, during a fastening process, the torque controller compares BPM values from the BPM detector with BPM corresponds to target torque specified at characteristic curve stored in the microprocessor to judge whether the output torques from the pulse tool fall within a tolerance range of target values or not, if not then show a warning signal, to thereby match a close loop control.

8. The torque control device of claim 7, wherein the BPM detector, torque calibration platform, and proportional valve are in communication with each other through wireless communication.
